(19) United States
(12) Patent Application Publication
(10) Pub. No.: US 2005/0132009 A1
(43) Pub. Date: Jun. 16, 2005

(54) Instant message awareness and migration allowing for multiple simultaneous client logins

(75) Inventor: Kevin Solie, Lexington, KY (US)

Correspondence Address: Steven M. Greenberg, Esquire;Christopher & Weisberg, P.A., Suite 2010, 200 East Las Olas Boulevard, Fort Lauderdale, FL, 33301, US

(73) Assignee: International Business Machines Corporation, Armonk, NY (US)

(21) Appl. No.: 10/733,667

(22) Filed: Dec. 11, 2003

(51) Int. Cl. G06F 15/16

(52) U.S. Cl. 709/206

(57) ABSTRACT

An instant message awareness system and method is provided. The invention provides a centralized model in which a server manages and stores the text transcripts of all instant message sessions and routes all instant message transcripts to all client devices for all the users involved in the session. Also provided is a decentralized model in which the server acts as a router and distributes the instant message transcripts to all active user client devices without actually storing and managing the actual transcripts. In the decentralized model, the invention further provides a migration process that migrates or merges the instant messaging sessions from one on-line computing device for a particular user to another on-line computing device, depending upon which device is deemed “active”. Therefore, the method and system of the present invention allows an on-line user to be able to have access to all of the user's current instant message sessions regardless of which on-line computing device the user is currently logged into and which device the instant message was sent to.

### BACKGROUND OF THE INVENTION

1. Statement of the Technical Field

The present invention relates to the field of online instant messaging (IM) and more particularly to a system and method for allowing a user with more than one online communication device to have access to instant message sessions on all of the user's devices regardless of which device the instant message was delivered to.

2. Description of the Related Art

Instant messaging is a phenomenon that is sweeping both the consumer and the corporate worlds. In the business world, instant messaging provides a communication platform that enables employees from multiple locations to communicate instantly over the Internet. While e-mail remains the prime on-line text communication method, instant messaging has proven to be a simple, on-line tool for real-time text messaging and has become a staple in day-to-day business operations.

Instant messaging is the ability to send and receive messages in real-time, independent of locale. Information exchanges can occur interactively when two users communicate in a conferencing window or passively when a user sends a static message to another user. Users, after having installed the necessary software on their on-line computing device, register a unique name with an IM provider. When the user logs-on to a central server, other users are notified that the user is now “available”. The messages can be sent either through the IM service's central server or directly from one computer to another, via to peer-to-peer technology.

The prime attraction of instant messaging is the ability for the user to carry on a real-time “conversation” with one or more other users, while sitting at their personal computer, while perhaps being involved simultaneously in other tasks. A user typically enters one or more e-mail addresses on a “buddy” list and is notified (by a visual and/or audio cue) when users having e-mail addresses corresponding to those on the user's buddy list are online. The user then has the option of transmitting an instant message to one or more of the “active” users. When members sign on or sign off their on-line devices, the user is notified and is therefore always kept aware of which other members can currently receive instant messages.

In the business setting, the advantages are enormous. For example, an employee may be on the telephone with an important client and be asked a question that he does not know the answer to but knows that his colleague in the next room may have the answer. Instead of asking the client to hold while the employee runs around the office looking for the person with the answer, the user can continue to converse with the client while sending an instant message to his colleague. The colleague, if logged on, can respond within seconds with the answer.

However, one of the drawbacks with typical instant messaging systems is that they do not allow users to view all current instant message sessions if the user has transferred to a new client device. For example, a user may be carrying several instant message dialogs or sessions with other users while sitting at his home PC. The user then moves to a different on-line device, for example, his mobile phone or his office PC. However, when the user logs on to the network via his new client device, he will not be able to view the ongoing sessions since he is no longer logged onto the Internet via his original client device (his home PC) but is instead logged on via his other on-line device.

In other words, the user has switched to a new “active” device but the system is unaware of this and is further incapable of transferring the IM session text to the newly activated device. The user, who may have had several simultaneous sessions with a number of different users on his home PC will no longer have access to those sessions. Today's IM systems prohibit a user from having an IM “presence” on more than one on-line computing device. It is desirable therefore to provide a method and system to allow an on-line user to be able to view all current IM sessions with other active members regardless of which on-line computing device the user is currently logged into.

### SUMMARY OF THE INVENTION

The present invention addresses the deficiencies in the art with respect to instant message user awareness and provides a novel and non-obvious method and system for allowing on-line users to have access to instant message notifications and text regardless of which on-line computing device they are currently logged into and regardless of which of their devices the instant message was sent to.

Methods consistent with the present invention provide a method for creating instant message awareness in a communications network for all of a user's on-line client devices. The method includes identifying an instant message session between two or more users, determining which client device for each user is active, and delivering text of the instant message session to the active client devices for the two or more users.

Systems consistent with the present invention include a system for creating instant message awareness for all of user client devices in a communications network. The system includes a database for storing text of instant message sessions, and a server coupled to the database and to one or more network users. The server contains a processor that identifies an instant message session between the users and determines which client device for each user is active. Finally, the server delivers the text of the instant message session to the active client devices for the two or more users.

In accordance with still another aspect, the present invention provides a computer readable storage medium storing a computer program which when executed performs an instant message awareness method. The computing method includes identifying an instant message session between two or more users, determining which client device for each user is active, and delivering the text of the instant message session to the active client devices for the two or more users.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an illustration of a communications network for sending and receiving instant messages including a server and a plurality of user terminals;

FIG. 2 is a flowchart illustrating the login procedure for a user using the centralized model of the present invention;

FIG. 3 is a flowchart illustrating the login procedure for a user using the decentralized model of the present invention;

FIG. 4 is a flowchart illustrating the message routing procedure for transmission of an instant message between user A and user B using the centralized model of the present invention;

FIG. 5 is a flowchart illustrating the message routing procedure for transmission of an instant message between user A and user B using the decentralized model of the present invention; and

FIG. 6 is a flowchart illustrating the message migration process of an instant message between user A and user B using the decentralized model of the present invention.

### DETAILED DESCRIPTION OF THE PREFERRED EMBODIMENTS

The present invention is a system and method that allows an on-line user to be aware of all instant messages sent to any of the user's on-line client devices regardless of which client device the user is currently logged into. The invention further allows the user to migrate all instant message sessions from all of the user's client devices to the currently active device.

The invention provides a centralized model, in which the server manages and stores the text transcripts of all instant message sessions and routes all instant message transcripts to all client devices for all the users involved in the session. Also provided is a decentralized model in which the server acts as a router and distributes the instant message transcripts to all active user client devices without actually storing the session transcripts. In the decentralized model, the invention further provides a migration process that migrates or merges the instant messaging sessions from one on-line computing device for a particular user to another on-line computing device for that user, depending upon which device is deemed “active”.

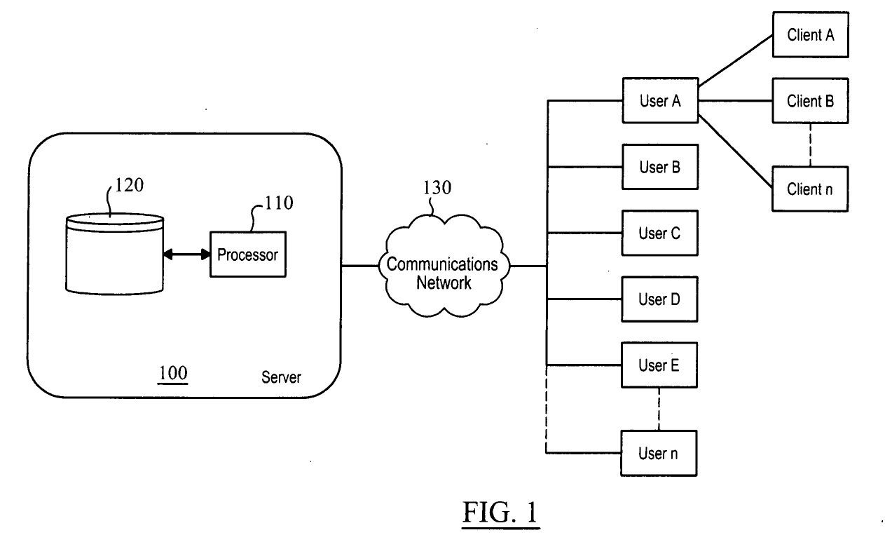

Referring now to the drawing figures in which like reference designators refer to like elements there is shown in FIG. 1 a block diagram of a system of the present invention including a communications network 130, a host server 100 and a plurality of users that may utilize the present invention. The routing of instant messages takes place between server 100 and users A-n resulting in real-time communication over a communications network such an Intranet (LAN/WAN), Extranet or Internet communication structure. Users A through N represent “on-line” users that maintain one or more on-line computing devices (clients). For example, user A may use a personal computer at his home (Client 1), a personal computer at his office (Client 2) a laptop computer (Client 3) and a mobile phone capable of receiving and sending text messages (Client 4). The same applies for other users in the communications network.

Server 100 includes a processor that manages and routes ingoing and outgoing instant messages between users. Server 100 also contains a database 120 that stores the text transcripts of the instant message sessions between users A through n. Users A-n represent communication network users that have registered their IM addresses with the server and are capable of receiving and sending instant messages on one or more on-line computing devices (clients) such as personal computers, Personal Data Assistant (PDA) and/or laptop or notebook computers. The present invention provides two embodiments to allow a user to have access to current instant message sessions with other users regardless of which client device they are presently using.

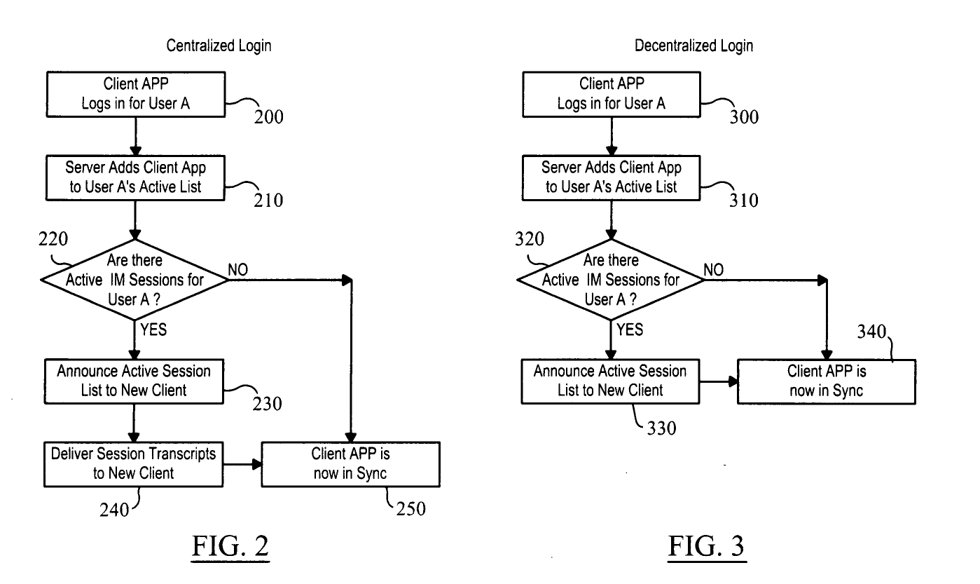

Referring to FIG. 2, a flow chart is shown illustrating the centralized model embodiment of the present invention. This process illustrates how an instant message (IM) application for a user, user A, is initialized using the centralized model embodiment of the present invention. In the centralized login process of FIG. 2, user A wishes to log onto the IM network of FIG. 1 using one of his client devices (step 200). The server receives this initiation request and adds the client, for example, user A's home PC, to user A's “active” client list. The server maintains a list of each user and their respective client devices. When a user signs onto a client device, the server updates the list to reflect that user A has signed on with a particular client device, which is now flagged as user A's “active” device (step 210). The server maintains a history of all instant message transcripts for all users and their client devices.

Once the server adds user A's recently activated client to user A's list, the server then determines if there are any active instant message sessions for user A (step 220). If there are instant message sessions active for user A, the server notifies user A's new active client by updating user A's session listing (step 230) and delivers the session transcript to the new client (step 240). The session transcript refers to the on-line dialog between user A and one or more other users. In this fashion, user A, having signed onto the network via a new client device, is now aware of all current IM sessions, even if an instant message was sent to a previously-active (and now non-active) user. Therefore, whether there are current active sessions for user A or not, each of user A's client devices are now synchronized (step 250) and user A can receive session transcripts to his or her currently active client.

FIG. 3 refers to the decentralized model login process of the present invention, where server 100 does not store session transcripts in memory as in the centralized model. Instead, the server in the decentralized model announces message sessions to the user's newly activated client device and migrates active IM sessions to the users' currently active device. In the login process of FIG. 3, and similar to the initial log-in process for the centralized model shown in FIG. 2, user A logs in a new client device (step 300) and the server recognizes this and adds the new (active) client to user A's active list (step 310). Once again, the server determines if there are any active instant message sessions currently active for user A (step 320) and if so, the server notifies the new client and provides an active session list (step 330).

However, because the server in the decentralized model does not store session transcript histories, the server does not deliver the session transcript to the new client. Instead, it notifies the new client of the existence of a new active session (i.e. it announces to the new client that another user is attempting to contact user A via an instant message), thereby synchronizing user A's new, active client, with user A's other client devices (step 340). Subsequently, via the migration process of the present invention, the server merges other session transcripts with the new client device.

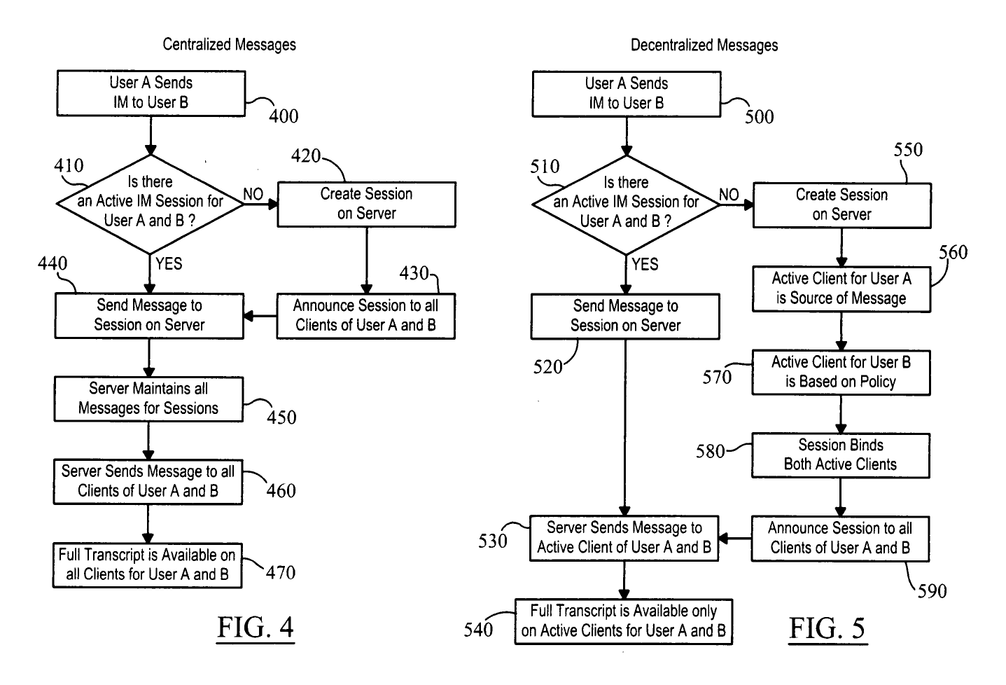

Once user A has logged onto the system via a new client device, the server controls the routing of instant messages between users. FIG. 4 illustrates the process used by the present invention to manage and route messages from various IM users in a communications network using the centralized model. FIG. 4 illustrates a two-user scenario, where user A sends an instant message to user B. However, the present invention is equally applicable to any number of users that are connected to the server and have client devices properly configured to send and receive instant messages.

As shown in FIG. 4, user A sends an IM to user B (step 400), and the server determines if there already exists an active IM session between user A and user B (step 410). If no session exists, the server creates an IM session (step 420) and announces the session to all the clients of user A and B (step 430). Therefore, although user B may have received an IM notification from user A at his home PC, user B's laptop or mobile phone will now also be notified of the existence of a message from user A. The centralized model shown in FIG. 4 synchronizes all of the user's clients after the session is created on the server.

If there is already an active IM session for user A and user B on the server, the existing session is updated to include the new message (step 440). Advantageously, the server, in the centralized model shown in FIG. 4, retains all messages for each session between users (step 450). Transcripts for the sessions are stored in memory. Therefore, the server not only serves to route incoming messages to their intended recipients but also stores the session transcripts. The server then sends the text of the new message to all of the clients of users A and B (step 460) and the full session transcripts are made available to all clients of user A and user B (step 470). Therefore, in the centralized model of the present invention, the server maintains control over the notification of all clients of the users, stores session transcripts, and routes full session transcripts to all of the users' clients.

Due to hardware constraints, it may not always be possible to provide a server with the memory and processor capacity to manage the instant message protocol as shown in FIG. 4. Therefore, a decentralized model is presented that shifts control of instant message management away from the network server, and provides a migration process that migrates instant message sessions to the IM users' currently active clients. This process provides users with IM “awareness” of all instant messages regardless of which client device the messages were originally intended.

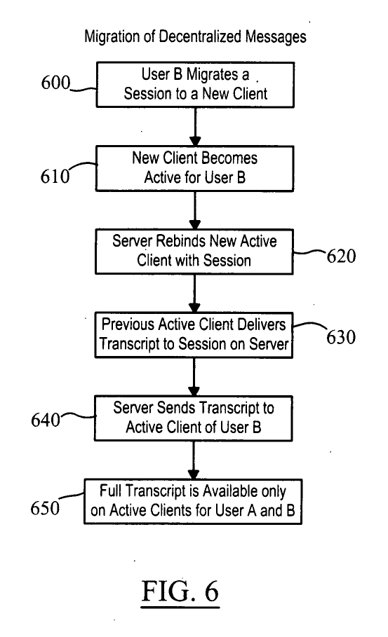

FIG. 5 presents a process whereby messages are routed to and from users without the server functioning to store all session transcripts. Similar to the centralized model illustrated in FIG. 4, a user A sends a message to user B (step 500), and the server determines if an active session already exists between the users (step 510). Again this illustrated process refers to a session between user A and user B but is expandable for multiple users and multiple sessions. If an active session already exists between user A and user B, then whatever client the users are currently operating from is deemed their “active” client. Therefore, the instant message is added to the current session and the server routes the new message to the currently active clients of users A and B (steps 520-530). This results in full session transcripts being made available only on the currently active clients of users A and B (step 540). FIG. 6 and the discussion below illustrates how the session transcripts migrate to a new client should one become active for one or both of the users.

Referring once again to FIG. 5, if there is no active session between the users, a session is created (step 550). Whatever client user A (the sender of the message) used to initiate the message becomes the “active” client for user A (step 560). The server recognizes the source of the message because user A must take action to initiate the message (i.e. a keyboard stroke or a mouse click). However, what is not readily apparent is which client of user B the message was intended for. For example, user A may have initially been carrying on an IM session with user B at user B's home PC. Later, user A sends another IM to user B at user B's home PC as part of the same session. The server detects the source of the message (via use A's active key strike or mouse click) but does not know which client of user B is the intended recipient. Therefore, the server determines the user B client by policy standards (step 570).

Because user B, the recipient of user A's instant message may have more than one client device, the server must determine which user B client user A's instant message was intended for, i.e. which of user B's clients will be “active” and receive user A's message. The server uses a listing of policy protocols to make this determination. For example, one protocol might be to designate the last client device user B was using as user B's active device. In another protocol, the recipient's client device may be determined to be the most frequently used client device of that particular user. Thus, if user B's home PC is the recipient of most of user B's instant messages, then his home PC is flagged as user B's “active client”.

Regardless of which policy is used, the server binds both active clients (step 580) and announces the session to all the clients of users A and B (step 590). Once again the server sends the message to the active clients of the users (step 530) and makes the session transcripts available to the active clients (step 540). However, in the scenario presented above, user B will not be aware of user A's latest IM since the message was sent as part of the ongoing session between user A and user B when user B was on his home PC. However, user B has moved to another client, for example, his office PC. Advantageously, the present invention provides a mechanism for recognizing that a new client for the recipient user (User B) has been activated and migrates the current session to this new client. Similarly, if user A, the sender of the instant message, transfers to a new client, the system recognize this as well and transfers the active session to the sender's new client. FIG. 6 illustrates this process.

FIG. 6 illustrates a process whereby user B has changed from one client device to another (step 600) and wishes to access his IM session transcripts from the user's currently active device. This can occur in at least two ways. For example, when user B connects to a new client device, he may be presented with a listing of all IM sessions that are on their previously active client and select one or more of them “on-demand”, and have them migrate to his current client. Alternately, the migration may occur automatically, i.e. as soon as the server detects a keystroke or mouse motion on the new client. An instant message that is delivered to a client that is currently inactive, or will be inactive shortly, is a candidate for auto-migration when another client of that user activates or comes online. When a user switches to a new client, then that new client (determined by either a user action such as a keyboard stroke or mouse click, or by policy) will be used for all new sessions until another “switch” is made.

In the example used above, user B has been in an IM session with user A but now transfers from his home PC and logs on via his work PC (step 600). Thus, user B's new client (his office PC) becomes the new active user for user B (step 610). The server, now recognizing that user B has logged onto a different client, rebinds this new active client with the previous session between user A and user B (step 620). Once the server has joined the new active client to the current session, the server sends a request to the previously active client for user B for the session transcript. The previously active client delivers all of the chat messages (text transcripts) of the IM session to the server (step 630), which sends the transcripts to user B's new active client (step 640). This results in the full session transcripts being made available on both user A and user B's currently active clients (step 650). Therefore, user B has successfully logged onto a new client, and can now view the entire text transcript of an instant message session that had been taking place on his previous (no longer active) client.

The system and method of the present invention allow an on-line user to switch to a new on-line client device and have access to instant message transcripts from instant message sessions that had been taking place on the user's previously used client device. In the centralized embodiment, the invention provides a server that not only routes instant messages from the sender to the recipient but also stores all message transcripts and makes the transcripts for each use session available to all clients of all the users. In the decentralized embodiment, the invention provides a system and method that routes a session transcript from a previously active client to the server, which then routes the transcript to the currently active device of the user. In either case, instant message users can receive messages sent to any one of their clients regardless of which client they are currently logged into, and, in turn, may send instant messages to other users on the network without any concern about which client device the other users are currently logged onto.

The present invention can be realized in hardware, software, or a combination of hardware and software. For example, the data handling policy can be stored in a database. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein. For example, the data handling policy can be stored in a database.

A typical combination of hardware and software could be a general purpose computer system having a central processing unit and a computer program stored on a storage medium that, when loaded and executed, controls the computer system such that it carries out the methods and functions described herein. The present invention can also be embedded in a computer program product, which comprises all the features enabling the implementation of the methods described herein, and which, when loaded in a computer system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

1. A method for creating instant message awareness in a communications network for a plurality of a user's on-line client devices, the method comprising:
identifying an instant message session between two or more users;
determining which client devices for each said user is active; and
delivering text of the instant message session to one or more active client devices for the two or more users.

2. The method of claim 1, wherein delivering text of the instant message session to the active client devices for the two or more users comprises:
joining the active client devices of the users to the instant message session;
retrieving the text of the instant message session from the users' previously active clients; and
transferring the text of the instant message session to the users' active clients.

3. The method of claim 1 wherein delivering text of the instant message session to the active client devices for the two or more users occurs when a user actively selects which instant message session is to be accessible on the user's client device.

4. The method of claim 1 wherein delivering text of the instant message session to the active client devices for the two or more users occurs without a specific user instruction when a user accesses the network from the active client device.

5. The method of claim 1 further comprising announcing the instant message session to the active client devices.

6. The method of claim 1 further comprising binding the active client devices to the instant message session.

7. The method of claim 1 wherein determining which client devices for each said user is active is based on policy.

8. A computer readable storage medium storing a computer program which when executed defines a method for creating instant message awareness for all of a user 's on-line client devices, the computer program performing a method comprising:
identifying an instant message session between two or more users;
determining which client device for each said user is active; and
delivering text of the instant message session to the active client devices for the two or more users.

9. The computer readable storage medium of claim 8 wherein delivering text of the instant message session to the active client devices for the two or more users comprises:
joining the active client devices of the users to the instant message session;
retrieving the text of the instant message session from the users' previously active clients; and
transferring the text of the instant message session to the users' active clients.

10. The computer readable storage medium of claim 8 wherein delivering text of the instant message session to the active client devices for the two or more users occurs when a user actively selects which instant message session is to be accessible on the user's new client device.

11. The computer readable storage medium of claim 8 wherein delivering text of the instant message session to the active client devices for the two or more users occurs automatically when a user accesses the network from the new active client device.

12. The computer readable storage medium of claim 8 wherein the method performed by the stored computer program when executed further includes announcing the instant message session to the active client devices.

13. The computer readable storage medium of claim 8 wherein the method performed by the stored computer program when executed further includes binding the active client devices to the instant message session.

14. The computer readable storage medium of claim 8 wherein determining which client devices for each said user is active is based on policy.

15. A system for creating instant message awareness for all of user client devices in a communications network, the system comprising:
a database for storing text of instant message sessions; and
a server coupled to the database and to one or more network users, the server containing a processor for identifying an instant message session between the users and determining which client device for each said user is active, the server delivering text of the instant message session to the active client devices for the two or more users.

16. The system of claim 15 wherein the server further joins the active client devices of the users to the instant message session, retrieves the text of the instant message session from the users' previously active clients, and transfers the text of the instant message session to the users' active clients.

17. The system of claim 15 wherein delivering text of the instant message session to the active client devices for the two or more users occurs when a user actively selects which instant message session is to be accessible on the user's new client device.

18. The system of claim 15 wherein delivering text of the instant message session to the active client devices for the two or more users occurs automatically when a user accesses the network from the new active client device.

19. The system of claim 15 wherein the server announces the instant message session to the active client devices.

20. The system of claim 15 wherein the server binds the active client devices to the instant message session.

21. The system of claim 15 wherein determining which client devices for each said user is active is based on policy.
